(19) United States
(12) Patent Application Publication
(10) Pub. No.: US 2011/0077984 A1
(43) Pub. Date: Mar. 31, 2011

(54) System for destination-based travel planning and booking

(76) Inventor: Terry K. Gilliam, North Kingstown, RI (US)

(21) Appl. No.: 12/661,306

(22) Filed: Mar. 15, 2010

Related U.S. Application Data
(60) Provisional application No. 61/210,098, filed on Mar. 13, 2009.

(51) Int. Cl. G06Q 10/00

(52) U.S. Cl. 705/6

(57) ABSTRACT

A method of travel planning and booking that allows a traveler to create on a website a profile of travel preferences, stores the profile of travel preferences, and allows the traveler to enter on the website a travel plan comprising a departure address, proposed destinations and arrival and departure times for each destination. It then identifies options for the travel plan based on the profile of travel preferences.

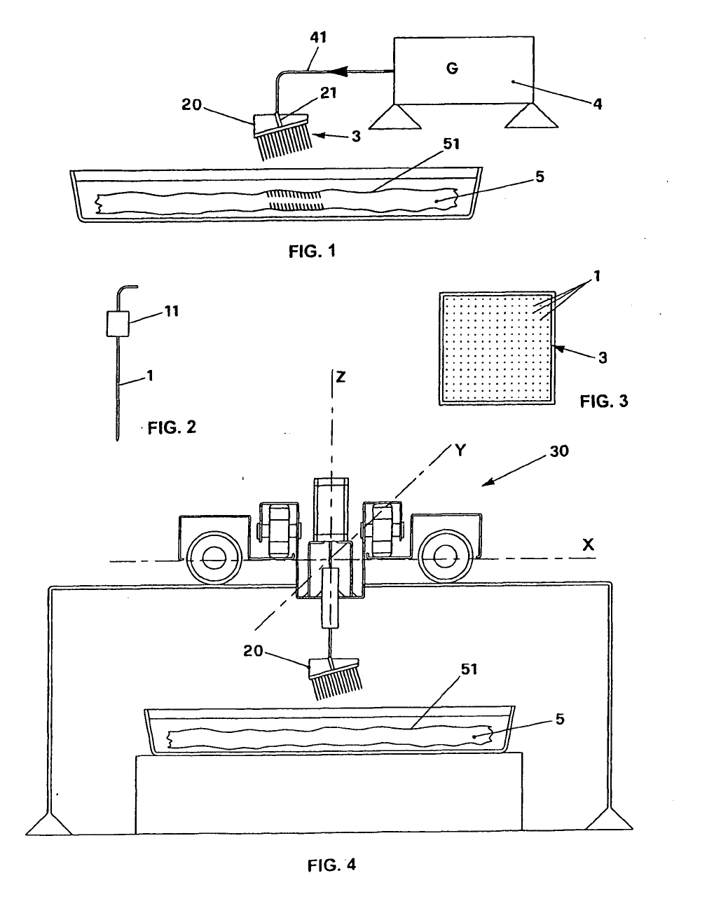

### CROSS-REFERENCE TO RELATED APPLICATIONS

The present application claims the benefit of Provisional Patent Application Ser. No. 61/210,098 filed Mar. 13, 2009, which is incorporated herein by reference.

### TECHNICAL FIELD OF THE INVENTION

The present invention relates to a method and apparatus for travel planning and booking. More specifically, it relates to a method and apparatus for destination-based travel planning and booking.

### BACKGROUND OF THE INVENTION

Today, travel planning puts the burden on the prospective traveler (the “traveler”) to research air, ocean and ground transportation; accommodations; dining; entertainment and sightseeing, and other points of interest, based upon planned dates of departure and arrival for each destination in an itinerary. A traveler must painstakingly research the options in each of these fields separately in an attempt to coordinate them into the best possible travel plan. The entire travel planning process may also be governed by budgetary and other parameters, such as special needs associated with diet restrictions and disabilities. Undertaken in the way required by websites such as expedia.com, travel planning for a complex itinerary involving several destinations and a variety of needs and preferences for a large family or group can quickly overwhelm a traveler.

For example, accommodations for a family for each destination in a three-city itinerary require researching accommodation locations and their proximity to the points of interest to the family in each city. Once these are ascertained, availability, affordability, dining options, children's programs, pet care and other criteria of the family must be researched and actual bookings made. The likelihood is that a family, or any group or its agent, will have to explore many options through many research iterations before finding just the right accommodations. Moreover, this iterative, time and energy-consuming process will need to be repeated for each destination in the itinerary.

Processes similar to that described to plan and book accommodations must be undertaken for inter-city travel (air, ocean and ground); for dining (restaurant ratings and type of cuisine); for intra-city travel to business appointments, meeting venues, vacation sights, entertainment venues, restaurants and other destinations (rental cars—which vendor and what type of vehicle; limousines, black car or full limousine; buses; taxis; and trains and class of service); for entertainment and sightseeing (availability, classes of services, cost, time options and reviews); for shopping (hours and locations of specific shops and most frequented shopping venues); and for festivals or other special events (times, costs, traditions, etiquette and the like).

### DETAILED DESCRIPTION OF PREFERRED EMBODIMENTS

The present invention is a system for destination-based travel planning and booking. A preferred embodiment of the present invention comprises a website at which a traveler—a registrant—registers and creates a profile of his travel preferences. Such a registration can include, among other information, business and residence addresses and associated contact information, preferences for classes and types of travel means (including specific carriers and seating), accommodations (including specific hotel names), dining (including minimum acceptable restaurant ratings, cuisines and table location preferences), and ground transport (including specific rental car providers or car services). Frequent traveler numbers can also be inputted. The registrant's information is then stored in any one of a number of types of memory known to those skilled in the art controlled by a central processing unit of a digital computer. The registrant is then issued a unique user identification and password.

A preferred embodiment of the system also allows a registrant to log onto the website and create a travel plan by inputting, for example, into a formatted html page, his departure address (home or business selected from profile), the destinations he plans to visit, the dates of such visits, and the desired arrival and departure times for each such destination. The website then provides radio dials or other means known to those skilled in the art, such as pull-down menus, to indicate for each destination the registrant's needs in a number of fields including, among others, desired travel means, accommodations, dining, ground transportation and sites the registrant might like to see or events he might like to attend at each destination and on what days and hours he would like to do so.

The preferred embodiment then factors in all of the registrant's travel preferences, as expressed in his profile, and presents available options to the registrant on a website or a mobile phone or other communication means, in every selected field. It does this through the central processing unit using search engines and other Internet tools and researching local websites at each destination to narrow down or illuminate the options in every one of registrant's chosen fields to fit within his preferred criteria. The registrant then accepts a preferred option, makes a different choice from the options presented, or overrides the system and enters his own option. Once registrant's selections are made, the system creates the itinerary and offers to book it, either in parts selected by the registrant, or in its entirety. Again, if the registrant accepts the offer, the system books the itinerary. It should be noted that the system can also provide the same services for a travel agent on behalf of a traveler. An additional preferred embodiment of the present invention is described in Appendix A attached hereto and incorporated herein by reference.

Once travel is underway, should there be any changes in plans, the system allows a registrant to access his itinerary to make the desired changes. It then rearranges the itinerary accordingly. This might involve cancellations, changes of time or other booking modifications. Itineraries are issued to registrants in both soft and optional hard copies, and the system retains copies of active itineraries on its servers.

The overall process described herein whereby the system plans and books travel maps to the way people think about business and personal travel and searches out the appropriate options for them, rather than requiring them to search out the air, ocean, ground, accommodations, dining particulars, etc. themselves, as is the case with all existing online travel sites.

Another preferred embodiment of the system can also learn with each use by a registrant. In this embodiment, a registrant logs onto the website and creates a travel plan and indicates his needs in a number of fields. For registrants who have not previously created a profile of travel preferences, the system presents available options to the registrant based on the most popular options (or some other criteria independent of the registrant's actual preferences) in each field. The registrant then accepts a preferred option, makes a different choice from the options presented, or overrides the system and enters his own options. For future travel plans for the registrant, the system can use algorithms based on past choices in a field to predict future choices in that field. For example, in a Boston, Singapore, Hong Kong, Boston itinerary, it can propose specific air carriers and hotels, for each destination based upon a registrant's prior selections. Any of these proposed choices can easily be overridden by the registrant.

In addition, in other preferred embodiments, the system can discover a better class of available services, for example, “business class” air or hotel, and advise the registrant of this and of the price difference to upgrade. Registrants can choose in their profiles whether or not they wish to be advised of the possibility of such upgrades.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

What is claimed is:

1. A method of travel planning and booking comprising,
allowing a traveler to create on a website a profile of travel preferences in at least one of the areas of transportation, accommodations, dining, entertainment and sightseeing,
storing the profile of travel preferences in memory controlled by a digital computer,
allowing the traveler to enter on the website a travel plan comprising a departure address, proposed destinations and arrival and departure times for each destination,
using the digital computer and one or more interne search engines to identify options for the travel plan based on the profile of travel preferences in at least one of the areas of transportation, accommodations, dining, entertainment and sightseeing,
presenting the identified options to the traveler,
allowing the traveler to select the identified options in whole or to select the identified options in part and to select different options in part, and
creating an itinerary based on the traveler's selections and offering to book the itinerary.
